(19) United States
(12) Patent Application Publication
(10) Pub. No.: US 2015/0170315 A1
(43) Pub. Date: Jun. 18, 2015

(54) Controlling Frame Display Rate

(71) Applicants: Eric C. Samson, Folsom, CA (US); Barnes Cooper, Tigard, OR (US)

(72) Inventors: Eric C. Samson, Folsom, CA (US); Barnes Cooper, Tigard, OR (US)

(21) Appl. No.: 14/108,442

(22) Filed: Dec. 17, 2013

(51) Int. Cl. G06T 1/20

(52) U.S. Cl. CPC G06T 1/20

(57) ABSTRACT

A system on a chip may include a central processing unit and a graphics processing unit. Based on a user specified target frame rate, it is determined whether a previous processor frame duration for either both of said central and graphics processing unit is too long. It so, at least one of the processors' idle times is decreased. In some embodiments, the frame rate is accessed only if the system on a chip is power limited. In some embodiments, the start of work on the graphics processing unit may be locked to a benchmark such as a v-sync signal or a completion of work on the graphics processor.

### BACKGROUND

This relates generally to frame display and more particularly to controlling a frame display rate.

Frame rate represents the rate at which frames are displayed in computer displays. A graphics engine generally maximizes the display frame rate of frames provided by graphics applications. The maximum possible frame rate for most real world applications is 60 frames per second. Higher frame rates typically provide higher visual quality. However, higher frame rates typically involve more power consumption. In a system where power use is to be reduced, such as battery-powered devices, reducing power consumption is more important.

A system on a chip (SoC) may include many different device components arranged on a printed circuit board package or even a single semiconductor die. Device components that may be present on a system on a chip include, for example, general purpose processor cores, graphics processing units, a memory controller, a display engine, caches, and power management units, to mention a few examples. Any time any peripheral device on the system on a chip is active and generates events, other components including processor cores and graphics processing units may be forced to assume relatively higher power consuming states even though the processor core functions may not be used.

### BRIEF DESCRIPTION OF THE DRAWINGS

Some embodiments are described with respect to the following figures:

FIG. 1 is schematic depiction of one embodiment of a system on a chip;

FIG. 2 is a depiction of a system on a chip duty cycle control;

FIG. 3 is a flow chart for one embodiment;

FIG. 4 is a system depiction for one embodiment; and

FIG. 5 is a front elevational view of one embodiment.

### DETAILED DESCRIPTION

A system on a chip may include a central processing unit and a graphics processing unit. Based on a specified target frame rate, it is determined whether a previous processor frame duration for either both of said central and graphics processing unit is too long. It so, at least one of the processors' idle times is decreased. In some embodiments, the frame rate is accessed only if the system on a chip is power limited. In some embodiments, the start of work on the graphics processing unit may be locked to a benchmark such as a v-sync signal or a completion of work on the graphics processor.

A frame rate control scheme allows a user to specify a target frame rate that does not change dynamically over time. Whenever a platform is capable of exceeding the user's specified target frame rate it instead decreases the frame rate it delivers to match the target and to reduce power consumption.

In some embodiments duty cycling may be used to coordinate the activity among various components on a system on a chip. As used herein, “duty cycling” refers to the forced or scheduled alignment of a succession of idle periods among multiple components. The duty cycling may further entail forced alignment of active periods among multiple platform components. Duty cycling accordingly involves cycling between forced idle and active periods.

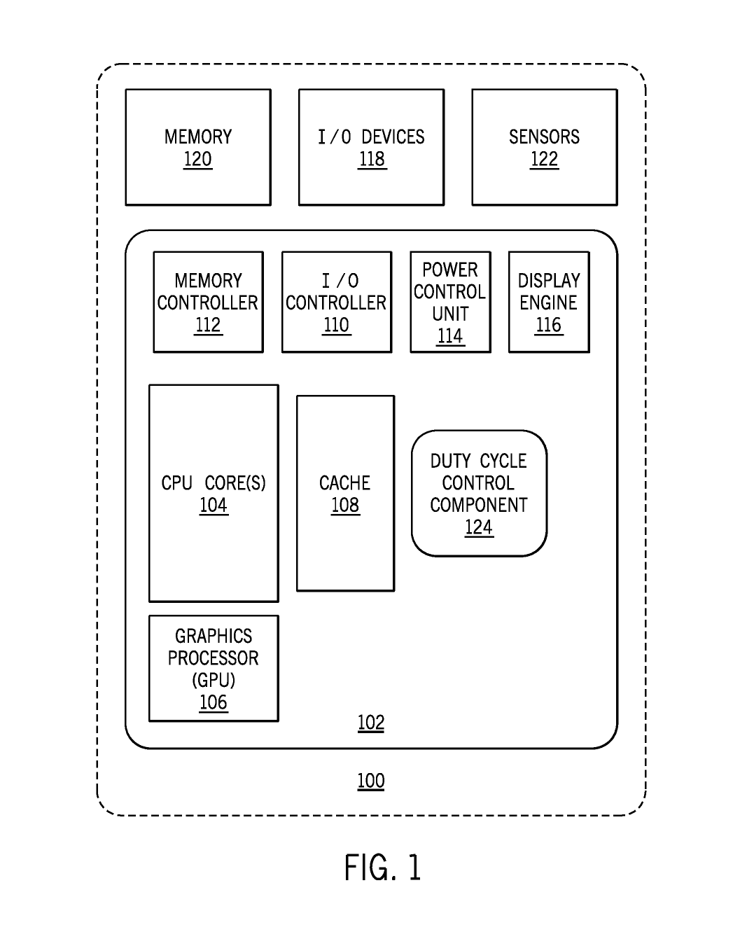

FIG. 1 illustrates a block diagram for a platform or system 100 consistent with the present embodiments. The system 100 is generally directed to at least performing general computing and graphics processing functions. However, in various embodiments a system such as system 100 may include conventional components additional to those shown in FIG. 1, and may perform additional functions such as conducting wireless communications, performing electronic imaging, and other functions.

As illustrated, the system 100 includes a set of components 102. In some embodiments the set of components 102 may be located on a single semiconductor die (chip), forming a so-called system on a chip. However, in other embodiments, the individual components of the set of components 102 may be dispersed among multiple different chips or may be dispersed across different physical systems and connected through a wired or wireless network or other communications medium. In the particular embodiment of FIG. 1, the system 100 includes CPU core(s) 104, graphics processor unit (GPU) 106, cache 108, I/O controller 110, memory controller 112, power control unit 114, display engine 116, I/O devices 118, memory 120, and sensors 122 In various embodiments the CPU core(s) 104 may include one or more CPU cores.

The system 100 may provide a more efficient and effective power management scheme to coordinate activity among the various components of system 100 without unduly sacrificing desired performance. In particular, the system 100 includes a duty cycle control component to facilitate maintenance of low platform power consumption by aligning idle periods of various components of the system 100 including the CPU core(s) 104, GPU 106, and other components of system 100. This helps avoid problems associated with conventional platform operation in which even small levels of activity in platform components that don't require CPU or GPU processing power may engender excessive power consumption by such devices. By aligning idle periods of CPU core(s) 104, GPU 106, and other components, overall platform power consumption may be reduced without impacting the performance capacity of the system 100 when fully active.

The duty cycle control component 124, by forcibly aligning or scheduling activity across multiple components of the system 100, may define one or more new lightweight power states for the platform 100. This produces a wider dynamic range of power levels that are accessible for the system 100 in comparison to conventional component-level power states that are defined in present day computing platforms.”

The duty cycle control component 124 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include drivers, power control units, software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

In particular embodiments, the duty cycle control component 124 includes logic at least a portion of which is in hardware and is included in a controller or processor. For example the logic may be included in a processor circuit linked to other components of system 100. In one particular example the logic forms part of a processor such as a CPU core(s) 104 and is communicatively linked to the other components of system 100. In other embodiments, the logic of the duty cycle control component 124 may be located in a controller such as the power control unit 114. In further embodiments, the duty cycle control component may be distributed across multiple platform components including cache and/or memory components. In operation, the duty cycle control component 124 may invoke duty cycling when appropriate for operation of the system 100. In some embodiments, duty cycling may be established as a default mode of operation for system 100. In particular embodiments, the duty cycle control component 124 may execute forced idle states on different components of the system 100 either independently or in unison, and may perform duty cycling in a manner that cycles portions of a system component separately from others. In addition, the duty cycle control component 124 may generate multiple different levels of duty cycling to accommodate requirements for different components of system 100.

In particular embodiments, as noted above, the duty cycle control component 124 initiates nested or hybrid duty cycling in which the number of components whose activity is aligned varies between different periods. This is particularly useful to address situations in which simultaneous alignment of activity among all components or among certain components of the system 100 may not be possible or desirable. For example the forced alignment of idle periods of CPU core(s) 104, GPU 106, and I/O devices 118 may be compromised by the limited idle duration for given I/O devices, given, for example, limited buffering capability.

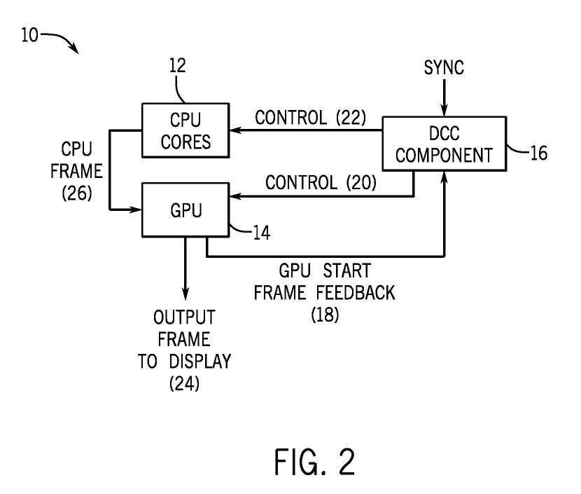

Referring to FIG. 2, system on a chip 10 may include a plurality of central processing unit (CPU) cores 12. The cores 12 may output a CPU frame 26 to a graphics processing unit (GPU) 14. The graphics processing unit 14 in turn outputs a frame to a display as indicated at 24. A duty cycle control (DCC) component 16 may provide control signals to the CPU cores 12 as indicated at 22 and to the graphics processing unit 14 as indicated at 20. Also, the graphics processing unit 14 may output a GPU start frame feedback 18 to the duty cycle control component 16. The GPU start frame feedback 18 may be used to synchronize the work of the CPU cores 12 with that of the graphics processing unit 14.

In some embodiments, available processing time from one of the graphics and central processing unit may be redeployed to the other based on the busyness of the other unit relative to the donating processor.

Frames per second is an indicator of just the right amount of work done by both the central and graphics processors. This is because the frames per second is a direct reflection of sufficient graphics processing unit visual quality.

A graphics processing unit frames per second target may be enforced by the DCC component 16 in one embodiment. The central processing unit work may be limited by the DCC component as well. In steady state, the component 16 produces one graphics frame for one central processing unit generated frame.

The central processing unit may be generating 60 frames per second. A reasonably well-written graphics application may implement at least double if not triple buffering. Then alignment of the central processing unit and graphics workloads may be encouraged by either phase locking the start of the next processing unit work to a sink boundary such as the vertical or v-sync boundary and/or phase locking the start of the next central processing unit work to the completion of the graphics processing unit's work.

Thus referring to FIG. 2, the graphics processing unit may provide feedback when it is about to complete its work so that the DCC component can issue an appropriate control signal to the CPU cores 12 to synchronize or lock the start of the central processing unit work to the graphics processing unit work.

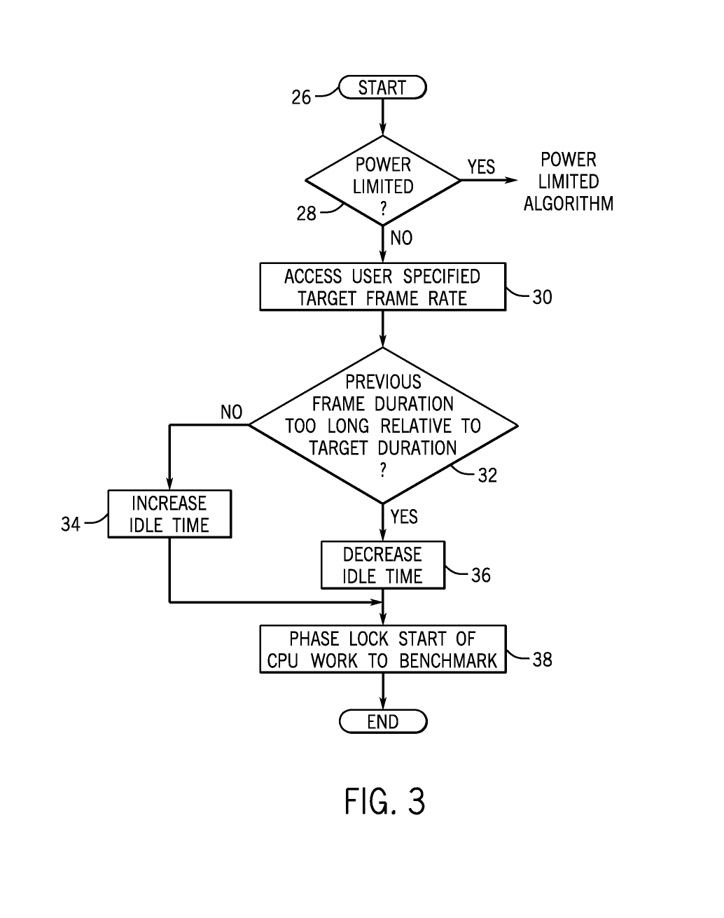

FIG. 3 is a depiction of a sequence 26 for implementing one embodiment. The sequence may be implemented in software, firmware and/or hardware. In software and firmware implemented embodiments, one or more processors may execute software resident in one or more non-transitory computer readable media such as magnetic, optical or semiconductor storages. For example, in one embodiment the sequence shown in FIG. 3 may be implemented by code stored in the DCC component 16.

The sequence 26 shown in FIG. 3 begins by determining diamond 28 whether the system on a chip is not currently power limited. The system is power limited when either or both of the CPU and GPU have no available idle time and frequency and/or voltage cannot be increased in view of an available power budget. If so, in some embodiments a user specified target frame rate is accessed as indicated in block 30. Then a check at diamond 32 determines whether the previous frame duration for the central processing unit is too long relative to a target duration needed to achieve the specified target frame rate. If so, the idle time of the central processing unit may be decreased as indicated in block 36. Conversely if it is not too long, then the idle time may be increased as indicated at block 34.

In some embodiments the target frame rate may be specified by the user. For example a graphical user interface may be provided to enable the user to specify a target frame rate. In other embodiments, the supplier of the graphics processing unit may provide a default or encoded target frame rate. In still other embodiments, the supplier of the equipment including the graphics processor may supply a default or predetermined target frame rate. Still another possibility is that the frame rate may be specified by the display.

Next at block 38 the from start or end of work of the graphics processing unit work may be phase locked to a benchmark. In one embodiment, the benchmark may be the graphics processing unit start frame feedback 18. For example this feedback may indicate when the graphics processing unit is about to complete its work. It may also be information about a vertical sync interval. In this way, the start of the next CPU work may be phase locked to an appropriate benchmark.

While an embodiment is described in which frame rate is controlled for a graphics processor and a central processing unit, the techniques described herein are applicable to any application where an engine generates a frame rate. An example of another application where a frame rate is generated is in connection with a camera image processing engine. Thus, embodiments may have applicability to laptop computers, desktop computers, tablets, cellular telephones, cameras, movie cameras, game devices and televisions to mention a few examples.

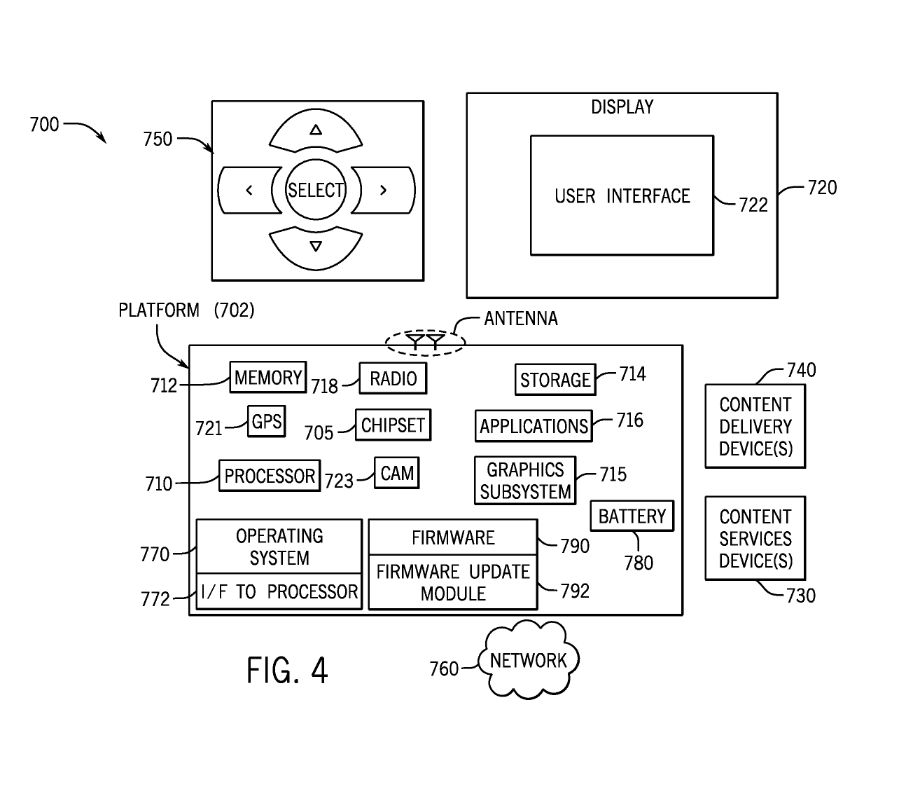

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 3 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the disclosed embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures, facial expressions, or sounds.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

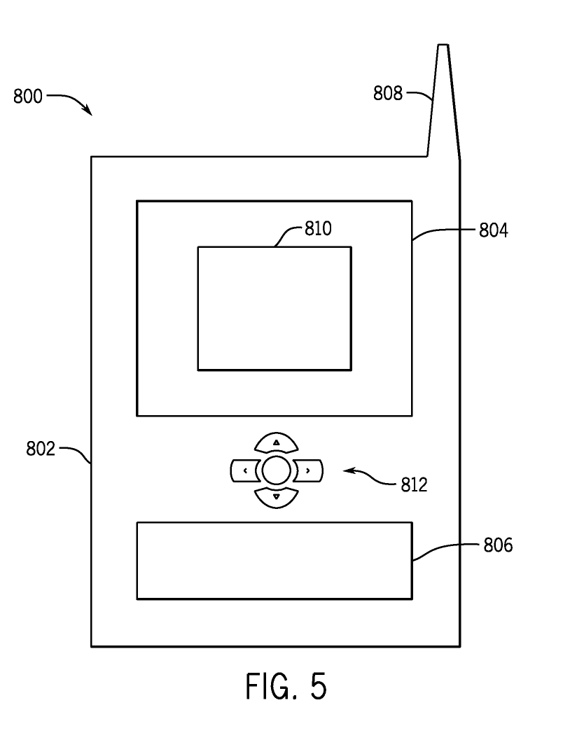

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 3 in software and/or firmware embodiments.

As shown in FIG. 5, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

The following clauses and/or examples pertain to further embodiments:

One example embodiment may be a method comprising accessing a target frame rate for an engine that generates a frame rate, determining whether a previous frame duration is too long relative to said target frame rate, and if so, decreasing idle time of the engine. The method may also include before accessing said frame rate, determining whether the engine is not power limited. The method may also include only if so accessing said target frame rate. The method may also include wherein accessing a frame rate involves accessing a frame rate for a system including a graphics processor and a central processing unit. The method may also include phase locking a frame start or end of work on the graphics processor to a benchmark. The method may also include wherein said benchmark is a synchronization signal. The method may also include wherein said signal is a v-sync signal. The method may also include locking the start of central processing unit work to completion of the graphics processing work. The method may also include wherein accessing a frame rate includes accessing a user specified frame rate. The method may also include wherein accessing a frame rate includes accessing a frame rate for a system on a chip.

Another example embodiment may be one or more non-transitory computer readable media storing instructions executed by a processor to perform a method comprising accessing a target frame rate for an engine that generates a frame rate, determining whether a previous frame duration is too long relative to said target frame rate; and if so, decreasing idle time of the engine. The media may include said method including before accessing said frame rate, determining whether the engine is not power limited. The media may include said method including only if so accessing said target frame rate. The media may include wherein accessing a frame rate involves accessing a frame rate for a system including a graphics processor and a central processing unit. The media may include said method including phase locking a frame start or end of work on the graphics processor to a benchmark. The media may include wherein said benchmark is a synchronization signal. The media may include wherein said signal is a v-sync signal. The media may include said method including locking the start of central processing unit work to completion of the graphics processing work. The media may include wherein accessing a frame rate includes accessing a user specified frame rate. The media may include wherein accessing a frame rate includes accessing a frame rate for a system on a chip.

In another example embodiment may be an apparatus comprising a processor to access a target frame rate for an engine that generates a frame rate, determine whether a previous frame duration is too long relative to said target frame rate, and if so, decrease idle time of the engine, and a storage coupled to said processor. The apparatus may include said processor before accessing said frame rate, said processor to determine whether the engine is not power limited. The apparatus may include said processor including only if so said processor to access said target frame rate. The apparatus may include said processor wherein accessing a frame rate involves accessing a frame rate for a system including a graphics processing unit and a central processing unit. The apparatus may include said processor to phase lock a frame start or end of work on the graphics processor to a benchmark. The apparatus may include said processor wherein said benchmark is a synchronization signal. The apparatus may include said processor wherein said signal is a v-sync signal. The apparatus may include a display communicatively coupled to the processor. The apparatus may include a battery coupled to the processor. The apparatus may include firmware and a module to update said firmware.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
accessing a target frame rate for an engine that generates a frame rate;
determining whether a previous frame duration is too long relative to said target frame rate; and
if so, decreasing idle time of the engine.

2. The method of claim 1 including, before accessing said frame rate, determining whether the engine is not power limited.

3. The method of claim 2 including only if so accessing said target frame rate.

4. The method of claim 1, wherein accessing a frame rate involves accessing a frame rate for a system including a graphics processor and a central processing unit.

5. The method of claim 4 including phase locking a frame start or end of work on the graphics processor to a benchmark.

6. The method of claim 5 wherein said benchmark is a synchronization signal.

7. The method of claim 6 wherein said signal is a v-sync signal.

8. The method of claim 5 including locking the start of central processing unit work to completion of the graphics processing work.

9. The method of claim 1 wherein accessing a frame rate includes accessing a user specified frame rate.

10. The method of claim 4 wherein accessing a frame rate includes accessing a frame rate for a system on a chip.

11. One or more non-transitory computer readable media storing instructions executed by a processor to perform a method comprising:
accessing a target frame rate for an engine that generates a frame rate;
determining whether a previous frame duration is too long relative to said target frame rate; and
if so, decreasing idle time of the engine.

12. The media of claim 11, said method including before accessing said frame rate, determining whether the engine is not power limited.

13. The media of claim 12, said method including only if so accessing said target frame rate.

14. The media of claim 11, wherein accessing a frame rate involves accessing a frame rate for a system including a graphics processor and a central processing unit.

15. The media of claim 14, said method including phase locking a frame start or end of work on the graphics processor to a benchmark.

16. The media of claim 15 wherein said benchmark is a synchronization signal.

17. The media of claim 16 wherein said signal is a v-sync signal.

18. The media of claim 15, said method including locking the start of central processing unit work to completion of the graphics processing work.

19. The media of claim 11 wherein accessing a frame rate includes accessing a user specified frame rate.

20. The media of claim 14 wherein accessing a frame rate includes accessing a frame rate for a system on a chip.

21. An apparatus comprising:
a processor to access a target frame rate for an engine that generates a frame rate, determine whether a previous frame duration is too long relative to said target frame rate, and if so, decrease idle time of the engine; and
a storage coupled to said processor.

22. The apparatus of claim 21 including, before accessing said frame rate, said processor to determine whether the engine is not power limited.

23. The apparatus of claim 22 including only if so said processor to access said target frame rate.

24. The apparatus of claim 21, wherein accessing a frame rate involves accessing a frame rate for a system including a graphics processing unit and a central processing unit.

25. The apparatus of claim 24 said processor to phase lock a frame start or end of work on the graphics processor to a benchmark.

26. The apparatus of claim 25 wherein said benchmark is a synchronization signal.

27. The apparatus of claim 26 wherein said signal is a v-sync signal.

28. The apparatus of claim 21 including a display communicatively coupled to the processor.

29. The apparatus of claim 21 including a battery coupled to the processor.

30. The apparatus of claim 21 including firmware and a module to update said firmware.
